(19) United States
(12) Patent Application Publication
(10) Pub. No.: US 2004/0171712 A1
(43) Pub. Date: Sep. 2, 2004

(54) Process for preparing high melt strength polypropylene and crosslinked prepared therewith

(76) Inventors: Telmo Manfrom Ojeda, Porto Alegre (BR); Shinichi Tokumoto, Canoas (BR); Antonio Luiz Duarte Bracanca, Porto Alegre (BR); Luis Fernando Cassinelli, Sao Paulo (BR); Ademar Benevolo Lugao, Sao Paulo (BR); Beatriz Weltman Hutzler, Sao Paulo (BR)

Correspondence Address: BIRCH STEWART KOLASCH & BIRCH, PO BOX 747, FALLS CHURCH, VA, 22040-0747, US

(21) Appl. No.: 10/240,537

(22) PCT Filed: Dec. 29, 2000
(86) PCT No.: PCT/BR00/00153

(30) Foreign Application Priority Data
Dec. 30, 1999 (BR) PI 9906018-3
Dec. 30, 1999 (BR) PI 9906023-0

(51) Int. Cl. C08J 3/28

(52) U.S. Cl. 522/5; 522/134; 522/135

(57) ABSTRACT

A process for preparing polypropylene and its copolymers of high melt strength while is kept melt index suitable for processing is described, the polypropylene and its copolymers being modified by grafting with high molecular weight portions and crosslinking with free radicals, both modifications being promoted by high energy ionizing radiation used at low doses in the presence of an atmosphere that contains crosslinking promoting gases, the polypropylene and its copolymers optionally containing stabilizing substances dispersed in the amorphous phase.

### FIELD OF THE INVENTION

The present invention relates to a process for preparing polypropylene and its copolymers having high melt strength. More specifically, the present invention relates to a process for preparing polypropylene and its copolymers, having high strength to shear free flow in the melt, while maintaining melt flow index suitable to processing. The process comprises the modification of polypropylene and of its copolymers through the cross linking of polymer macroradicals and grafting of high molecular weight chain branches, both modifications being simultaneously provided by high energy ionizing radiation used at low dose, under an atmosphere containing crosslinking promoting gases, and the polypropylene and its copolymers optionally containing dispersed stabilizing substances in the amorphous phase.

### BACKGROUND INFORMATION

Polypropylene (PP) is a semi-crystalline thermoplastic, and predominantly isotactic polymer. Its polymerization occurs mainly through Ziegler-Natta catalysts; therefore it is basically a linear chain polymer, possibly completely linear.

However, PP shows low melt strength in the shear free flow, which render several difficulties in applications as the manufacture of low density foams, coating films, thermoformed parts with complex geometries and large dimensions, blow molding of large parts and sheet extrusion.

Most of the PP processing technologies, particularly those mentioned above, submit the molten material to deformations known as elongation and shear free. Those deformations or shear free flows are extremely sensitive to the ultra high molecular weight fractions (Mw>106) and to the existence of long branches.

In shear free flow the melt strength is required to keep the stability in high processing rates and avoid draw down propagation until eventual breaking. Even if this limit is not reached, a phenomenon known as draw resonance may occur, which is evidenced by cyclic variations in the gauge pulsation, with the consequence of various problems, possibly even the breaking of the extrudate.

For a given application, there is always a suitable concentration of ultra high molecular weight molecules, in which the entanglements and the long relaxation times contribute to impart the ideal rheological behavior. On the one hand, the ultra high molecular weight fractions are necessary to impart elasticity and free flow strength to the melt, but on the other hand they might bring heterogeneity in the distribution of normal stresses, causing draw resonance or other undesirable elastic effects.

The universally adopted solution in the PP industry has been to make blends of high molecular weight PP, that is the high melt strength component, with low molecular weight PP, that is the high melt flow index component, in order to obtain a balance between the properties of melt strength and melt flow index required for the blend. Such solution has not being satisfactory, once in order to increase the melt strength it is required to appeal to increasing amounts of high molecular weight PP, which must be balanced with a lower molecular weight PP, jeopardizing not only the processing properties but also the mechanical properties of the end product.

Of course, in order to minimize the low performance, various other solutions were advanced as well as blends were developed, mainly based on low density polyethylene, without however obtaining the desired

High-energy irradiation processes are well known for several purposes, for example, sterilization of end products of polyolefins such as polypropylene and polyethylene. In spite of the discovery of the predominance of oxidative degradation reactions and the existence of some level of crosslinking, few references relate modifications in rheological properties for the processing of the polymer consequent to radiation.

U.S. Pat. No. 3,714,083 teaches a process for producing a foamed article from polypropylene which has been modified through ionizing radiation with 0.1 to 5.0 megarads intensity and grafting the irradiated polypropylene with divinyl benzene or acrylic acid esters.

U.S. Pat. No. 3,816,284 teaches a process for increasing the thermal strength of a cell polyethylene through irradiation with ionizing radiation in the presence of crosslinking agents, which comprise acetylene compounds and/or allene compounds and a vinyl monomer.

Brazilian PI BR 8600413 and U.S. Pat. No. 4,916,198 relate to a process and product that comprise:

1) Irradiating a propylene polymer in an environment where the concentration of active oxygen is set and kept 15% below that found in the normal atmosphere and with ionizing radiation at rates of 1 to 1×104 megarads per minute during a period of time suitable to yield substantial amount of chain breaking, but insufficient to cause gelation of the material;

2) Keeping the so-irradiated material in said environment for a sufficient period of time in order to form substantial amount of long chain branching;

3) Treating the irradiated material while in said environment in order to substantially deactivate all the free radicals present in the irradiated material;

U.S. Pat. No. 5,200,439 teaches a process for increasing the intrinsic viscosity of syndiotactic polypropylene having initial values of from 0.1 dl/g to 5 dl/g which comprises irradiating polypropylene in the absence of oxygen and then heating the irradiated syndiotactic polypropylene until the radicals formed by irradiation disappear.

U.S. Pat. No. 5,541,236 teaches a process for irradiating the propylene polymer in a way similar to the one described in U.S. Pat. No. 4,916,198, however, where the propylene polymer is a blend of propylene with various specific copolymers.

U.S. Pat. No. 5,554,668 teaches the process of irradiating the propylene polymer in a way similar to that described above, however, starting from propylene homopolymers or copolymers of propylene and olefin of the ethylene group, and alpha-olefins in C₄-C₁₀ and dienes in C₄-C₁₀.

U.S. Pat. No. 5,594,041 teaches a method to increase the structural integrity of the polymer surfaces using the combination of high energy radiation and crosslinking agents; the method is applied to reduce the permeability of the organic polymers selected among nylon, high density polyethylene and polyethylene terephthalate, while the method is applied to increase the resistance of the surface to scratching in of the organic polymers selected among the polyethylene terephthalate, the ultra high molecular weight polyethylene; the polymethyl methacrylate and the polycarbonate. The source of the high energy radiation is an energetic beam of small bulk ions.

Recently, F. Yoshi et al. in the Journal of Applied Polymer Science, vol. 60, p. 617-623 (1996) developed a process for the synthesis of HMSPP (High Melt Strength Polypropylene) based on the simultaneous irradiation of PP with bifunctional acrylic monomers in order to create crosslinking or grafting below the gel point. The process uses, as steps of thermal treatment, heating at 80° C. to allow recombination of the radicals and heating at 130° C. to make possible that the remaining radicals are eliminated. It was found that the process is able to yield PP of high melt strength from irradiation doses much lower than those of other references, typically of 1 to 10 kGy. The suggested system was efficient in increasing the melt strength; however there was a contamination through non-reacted acrylic monomers and oligomers, this precluding various applications, as well as undesirable changes in the mechanical properties of the polymer.

Therefore the technique still needs a process for preparing polypropylene and its copolymers modified by radiation, containing optionally stabilizing substances dispersed in its amorphous phase, where the presence of a crosslinking-promoting gases-containing atmosphere allows that the high-energy ionizing radiation be used at low intensity, the resulting product showing improved strength to shear free flow in the melt, while keeping melt index values suitable to processing and absence of contaminants, such process being described and claimed in the present invention.

### SUMMARY OF THE INVENTION

The present invention relates to a process for preparing polypropylene and its copolymers having high melt strength, such process comprising:

Irradiating, with the aid of low doses of ionizing radiation, polypropylene and its copolymers in the presence of a reactive atmosphere, containing at least one crosslinking promoting gas, so as to obtain a degraded, crosslinked polypropylene grafted with high molecular weight chain branches;

In a first treating step, herein called recombination step, keeping the polypropylene and its copolymers irradiated at a certain temperature, during a certain period of time, that makes possible to recombine most of the free radicals still remaining;

In a second treatment step, herein called termination step, eliminating any remaining free radicals of grafted and crosslinked polypropylene and its copolymers;

Optionally, the polypropylene and its copolymers containing an amorphous phase may be added stabilizing substances so that such substances are dispersed in the said amorphous phase throughout all the process steps.

Thus, the present invention provides a process for preparing polypropylene and its copolymers having high melt strength in the presence of ionizing radiation of low intensity and gaseous crosslinking promoters while keeping the melt index adequate for processing.

The present invention provides also a process in which the crosslinking promoting gases, that are unsaturated compounds that further act as radical scavengers, act also to stabilize the polymer.

The present invention provides still a process for preparing polypropylene and its copolymers of high melt strength the end product of which is free of contaminants that may jeopardize its applications, in view of the extremely high volatility of the crosslinking promoters used. The polypropylene and its copolymers according to the present invention are also free of the presence of by-products of the oligomerization reactions or even polymerization of such crosslinking promoters in detectable amounts after the processing in the melt.

### DETAILED DESCRIPTION OF THE PREFERRED EMBODIMENTS

In the present invention, the meaning of the following expressions is as below:

Mn: number average molecular weight of the polymer;

Mw: weight average molecular weight of the polymer;

Mz: average molecular weight related to the high molecular weight fractions.

More detailed information on the above definitions may be found in the “Polymer Science Dictionary”, by Mark S. M. Alger, Elsevier Applied Science, 1st edition, 1989, p. 270.

Melt Index is the result of the test effected according to the ASTM Method D-1238, which consists in the measurement of the extrusion time of a sample of polymer melt through a capillary and a die of fixed length and diameter, under stable temperature and pressure conditions. The melt index is expressed in g/10 min.

Gray (Gy) is the unit of the International System for dose of energy absorbed by unit of mass of the irradiated material, submitted to the ionizing radiation. One gray is equal to the absorbed dose of 1 joule per kilogram. One rad is equal to the absorbed dose of 0.01 joule by kilogram or 0.01 Gy.

The process of the present invention comprises the irradiation of PP and its copolymers in the presence of one or more crosslinking promoting gases followed by treatment steps for the recombination and termination of free radicals, according to the cited features when gamma sources are used.

The process suggested in the present application, using crosslinking promoting gases as reactive medium comprises:

1) Irradiating a polymer of polypropylene and its copolymers in an environment where there is a concentration of a reactive gas or a mixture of reactive gases, where the concentration of oxygen should preferably be maintained at the lowest possible level; however, the atmosphere of the reaction system may contain oxygen until the concentration of 28% molar, since the degrading effects of active oxygen are counteracted by the crosslinking promoting gases. Ionizing radiation dose rates from 0.01 kGy/min to 1×105 kGy/min should be used for a sufficient period so as to occur a substantial amount of breaking of the propylene polymer chain, but insufficient to cause gelation of the material when measured by extraction in evaporating xylene;

2) In a first treating step, herein called recombination step, keeping the so-irradiated material in said ambient for a sufficient period of time to form substantial amounts of crosslinking and long chain branching, optionally, the temperature may be increased to speed up the recombination process;

3) In a second treating step, herein called termination step, treating the irradiated material at temperatures near the crystalline melt (higher or lower), while it is in said environment in order to substantially deactivate all the free radicals present in the irradiated material, optionally, this termination step may be carried out using scavenging radical gases in order to annihilate any remaining free radicals with the aid of termination reactions, as a replacement to the recombination of macroradicals accelerated by temperature.

4) Optionally, the polypropylene and its copolymers containing an amorphous phase may be added of stabilizing substances so that such substances are dispersed in the said amorphous phase throughout all the process steps.

The crosslinking promoting gases themselves, that are unsaturated compounds which also act as radical scavengers, have a stabilizing action on the polymer.

According to the present invention, the expression reaction system comprises the following equipment or accessories:

The radiation source to be used, that is, gamma source or electron accelerators, using doses between 5 kGy and 80 kGy, preferably between 10 kGy and 40 kGy, at dose rates typical for industrial gamma sources and electron accelerators, that is respectively 1 kGy to 60,000 kGy;

Besides those, other types of gamma rays or X rays may be used, such as high energy accelerators with X-ray converters.

If the source used is a gamma source, then one alternative for a batch process is described as follows:

A vessel made of stainless steel 304 or of any other material capable of withstanding multiple gamma ray irradiation and heating until 200° C. and is compatible with the handled products;

The volume of the vessel should be approximately the same as that of the volume to be irradiated, and may be larger, this not representing any restriction to the efficacy of the reaction;

The PP to be irradiated may be an isotactic homopolymer, the tacticity being sufficiently high to render the polymersemicrystalline. Preferably a commercial isotactic PP alone or copolymers of alpha-olefins also alone or admixed with homopolymers or admixed among themselves are used;

The PP may present various specifications in terms of molecular weight and its distribution; preferably is used PP of Mn between 40,000 and 100,000 and Mw between 100,000 and 4,000,000. The choice will be a function of the final application of the product, in view of the relationships between melt strength and melt index;

The physical form of the polymer or copolymer of polypropylene to be submitted to the irradiation process is not critical, and it may be any of the usual shapes normally found in the market. In the optional case where there is the need of antioxidants dispersed in the amorphous phase, the preferred shape of the present invention is the pelletized or extruded PP, that is melt PP admixed to antioxidants during the extrusion/pelletization process. Other possible shapes for polypropylene and its copolymers are flakes, pellets, spheres or powder;

The stabilizing substances optionally used may be the hydrogen donor and radical scavenger substances or compounds usually employed, such as phenolic antioxidants, aromatic amines, sterically hindered amines, hydroxylamines and substances or compounds that decompose hydroperoxydes such as phosphites, phosphonites and organo sulphuric compounds, or still bifunctional or polyfunctional stabilizing substances having more than one function in the same molecule or optionally a mixture of more than one substance among those conventionally used for the control of the polymer degradation during the processing and aging;

In the optional case when stabilizing substances dispersed in the amorphous phase of PP are used, typical concentrations of stabilizing substances should be used, that are normally applied by the PP manufacturing industries or by the processors in order to avoid the thermo-oxidative degradation of PP. However, the concentration range may be very broad, from tiny concentrations such as 1 ppb until extremely high concentrations, well superior to the solubility limit of the antioxidants in the amorphous phase, for example, 10 to 20%, since in the end applications the inventive PP may be admixed in varied amounts to virgin PP. Preferably, the stabilizing substances may be used in concentrations between 0.001 and 2 weight % related to the virgin polymer;

The crosslinking promoting gaseous atmosphere comprises the use of acetylene compounds (HC≡CR₁), allene compounds (CH₂═C═CR₁R₂) or vinyl compounds (R₂R₁C═CR₃R₄), however, acetylene is the preferred gas in view of its efficacy and low cost;

The crosslinking promoting gases may be alone, admixed among themselves, admixed to a great variety of inert gases or even contaminated with active oxygen in concentrations higher than 15%; however, preferably acetylene is used alone;

Acetylene may optionally be admixed to radical scavenging radicals, such as the mercaptans that are gaseous at the reaction temperature or nitrogen compounds also gaseous at the temperatures of irradiation and of the recombination and termination steps.

The irradiation, recombination and termination steps may be carried out under a continuous process or batch process;

The irradiation source to be used in case of gamma radiation from Cobalt-60 or Cesium-137 disintegration may have many varied configurations and activities. It should be noticed that higher activities, or higher dose rates at the same distance imply in lower irradiation periods, this being convenient from the operation point of view without jeopardizing the intended property;

The first and second treatment steps (recombination and termination) may advantageously be carried out in the same vessel where the irradiation is effected;

The typical temperatures and periods of the recombination step are of the order of 10° C. until 100° C. during 5 minutes to 1 month depending on the temperature used. The higher the temperature used in the recombination step, the lower the time required to remain at that temperature;

The typical temperatures and periods of the termination step, when this is effected thermally in an oven, are of the order of 100° C. until 155° C. during 0.1 minute to 100 minutes depending on the temperature used. The higher the temperature used in the termination step, the lower will be the time required to remain at that temperature;

Optionally, the thermally effected termination step may be done directly in an extruder where the polypropylene and its copolymers irradiated are melted and have all the remaining free radicals withdrawn, by heating at temperatures between 175° and 260° C. during 1 to 5 minutes stay of polypropylene and its copolymers in the interior of the extruder;

the typical temperatures and periods of the termination step, when it occurs chemically with the aid of radical scavenging gases, are of the order of 10° C. to 180° C. during 0.1 minutes to 100 minutes, depending on the temperature used;

the optional addition of stabilizing substances to polypropylene and its copolymers is effected using any of the known techniques for dispersing substances in polymer amorphous phases. Preferably, such addition is effected using extrusion or pelletization of the stabilizing substances together with the polymer;

before the irradiation, the polymer should be kept in the gaseous atmosphere during a sufficient time so it is impregnated by the gases of the reactive atmosphere. The minimum, impregnation time should be around 1 minute depending on the granulometry and porosity of the polymer. Higher periods, even 24 hours, are enough to practically attain equilibrium, no matter the granulometry of the system;

the impregnation operation may be repeated in order to assure higher purity of the gases present in the reaction system.

Continuous irradiation systems in gamma are possible and desired when rendered viable through a high production volume. Such systems basically comprise a closed system in a reactive atmosphere, made up of a charge vessel and impregnation of the gases out of the irradiation chamber, a system for transporting the polymer to the interior of the chamber, a heating system in one or two steps and a discharge system.

The irradiation system using accelerators should take into consideration the lower electron penetration. Therefore, in the case of batch irradiation the vessels should have the thinnest and less dense possible walls. For example, polyester bags may be adequately used in some configurations Advantageously, vessels based on polymer and metal foils may be used. In the case of continuous irradiation several irradiation systems under inert atmosphere have already been developed that are known from the experts in radiation processing. Similar concepts may be applied to the process disclosed in the present invention.

Polymers that are useful for the inventive process comprise mainly PP and its isotactic, high molecular weight copolymers having isotacticity degree higher than 80% and lower than 99.9%. The inferior limit of acceptable isotacticity is the amount that allows semicrystalline PP to be formed.

Equally useful are copolymers or mixtures of homopolymers and copolymers, the copolymer having alternatively as comonomers other alpha-olefins of formula CH₂═CHR, wherein R may be a linear or branched alkyl, the number of carbon atoms being between two and eight, or a hydrogen atom. More specifically, the copolymers present as monomers, besides propene, ethene, 1-butene, 1-pentene and its branched isomer 3-methyl-1-butene, 1-hexene and its branched isomer 4-methyl-1-pentene, 1-heptene, 1-octene, 1-nonene and 1-decene. The mixtures should be carefully made compatible relative to the desired properties of the end product and to the doses used in the process, since each copolymer and each mixture presents a different sensitivity to radiation.

Contrary to the practice of the known processes, the crosslinking-promoting gases aim at rendering possible the use of low intensity radiation without the use of crosslinking promoters in the liquid state.

Useful crosslinking promoting gases in the present process comprise acetylene compounds (HC═CR₁), allene compounds (CH₂═C═CR₁R₂) or vinyl compounds (R₂R₁C═CR₃R₄), alone or combined, provided they are in the gaseous state and at room temperature and pressure. Examples or these compounds are acetylene, methyl acetylene, ethyl acetylene, propyl acetylene, vinyl acetylene, propadiene, 1,2-butadiene, 1,3-butadiene, ethene, propene, 1-butene; iso-butene, vinyl chloride, vinylidene chloride, vinylidene fluoride, chlorotrifluoro ethylene and tetrafluoro ethylene.

The crosslinking promoting compounds are used alone or in admixture with inert gases which do not promote crosslinking reactions. Examples of these gases are nitrogen, methane, ethane, propane, helium and argon. Technically other rare gases may be used. The presence of oxygen in amounts until 28% in the molar composition of the reaction atmosphere is possible, however, the presence of oxygen should be minimal, and preferably nil. Radical scavenging gases may also be used, such as nitric oxide and mercaptans.

The stabilizing substances that are suitable to be optionally added to the amorphous phase of the polymer are pure substances or mixtures of substances, monofunctional, bifunctional or polyfunctional, that contain chemical groups that work through:

a) hydrogen donation

b) radical scavenging

c) hydroperoxide decomposition.

Among the products that contain chemical groups that work through hydrogen donation are the phenolic antioxidants, the aromatic amines; the sterically hindered amines and the hydroxyl amines.

Among the products that contain chemical groups that work through radical scavenging are the benzofuranone related products and the compounds that contain unsaturated groups. The compounds that contain unsaturated groups may be monomers or oligomers. Advantageously in this option may be used the own gases used in the composition of the atmosphere as crosslinking promoters such as the gases of the acetylene (HC═CR₁), allene (CH₂═C═CR₁R₂) or vinyl (R₂R₁C═CR₃R₄) type.

The acetylene gases that may be used are acetylene, methyl acetylene, ethyl acetylene, propyl acetylene and vinyl acetylene.

The allene gases that may be used are propadiene and 1,2-butadiene.

The vinyl gases that may be used are 1,3-butadiene, ethene, propene, 1-butene, iso-butene, vinyl chloride, vinylidene chloride, vinylidene fluoride, chlorotrifluoro ethylene and tetrafluoroethylene.

Among the products that contain chemical groups that work through hydroperoxide decomposition are the phosphites, the phosphonites and the organosulfur compounds.

The inventive process may be carried out at lower than atmospheric pressures or advantageously at higher than atmospheric pressures. Preferably the total pressure of the reaction system during the irradiation should be situated between 0.5 bar and 20 bar absolute pressure. The partial pressure of the crosslinking promoting gas may be between 0.01% and 100%, however it should be preferably between 10% and 100% of the total pressure of the reaction system for more effectiveness. The partial pressure of the radical scavenging gas optionally used may be between 0% and 99.9%, preferably between 0.01% and 90%.

The ionizing radiation useful for the practice of the invention may be from gamma rays sources, X-rays sources or electron accelerators, using doses between 5 kGy and 80 kGy, preferably 10 kGy and 40 kGy at dose rates typical of gamma sources and industrial electron accelerators, that is, respectively 1 kGy/h to 60,000 kGy/h, the source used defining the remaining of the reaction system. The energy of the accelerator should be used so that the electron penetration is sufficient to irradiate all the polymer bulk. Other sources of rays or of X-rays may be used, such as, high-energy electron accelerators with X-ray converters.

Elongational viscosity is the resistance of a fluid to elongational flow. It can be determined by the force need to stretch the specimen in the molten state at an increasing speed. The melt strength is defined as the maximum force reached in this test. From the same experiment, extensibility value is also taken. This property is defined here as the speed that the strand breaks. The extrudate swelling constitutes an indirect form of determining an increase in the melt strength (MS), since it is also caused by an increase in the elastic forces.

In the present application, the use of the crosslinking gases differs from the function of the gases in U.S. Pat. No. 3,816,284 according to the following points:

in the cited literature, irradiation occurs in the end product, contrary to the present invention in which the raw material is irradiated;

in the cited literature, the irradiation is carried out in order to obtain the highest possible gel fractions while in the proposed technique a polymer essentially free of significant gel fractions is desired;

polyethylene shows a predominant trend to crosslinking under radiation and polypropylene shows balanced trends between crosslinking and grafting of long chain branching.

Still, the polypropylene obtained according to the process of the invention shows relevant differences relative to the product and/or process described in U.S. Pat. No. 4,916,198 as stated below:

the locus where the stabilizing additive, in this case a phenolic antioxidant, is found in the polymer. In the optional case of the present application, the stabilizer of interest is contained in the amorphous phase of the polypropylene, while in U.S. Pat. No. 4,916,198 the locus of the polymer where the antioxidant is to be found is not specified;

the influence of the stabilizer for obtaining PP of high melt strength. In U.S. Pat. No. 4,916,198, the use of the antioxidant did not have any specified reaction purpose, the reaction system used inert gases, therefore the antioxidant did not participate in any reaction with the polymer or with the atmosphere. In the present application the optionally employed antioxidant has a fundamental reaction role, reducing the amount of total dose required to obtain high melt strengths.

The PP obtained through the method of the application shows a higher amount of crosslinking and a lower level of grafting as compared with the product of U.S. Pat. No. 4,916,198, which according to the authors shows long chain branching only.

In the present invention, there is no need to use inert gases. However it is possible to use them, preferably with radical scavenging reactive gases and with crosslinking promoters alone or in admixture;

The process of the present application uses lower overall irradiation doses for similar effects in the increase of the melt strength, due to the use of effective crosslinking promoting gases, to the effective control of the PP degradation through the use of the optional action of PP stabilizing substances dispersed in the amorphous phase and to the use of radical scavenging gases;

The process of the present application when based on a crosslinking promoting gaseous system the kinetics of which will be a function of the acetylene diffusion in the amorphous phase of the polymer, allows the use of conventional industrial gamma sources, the irradiation costs being directly proportional to the dose. The typical values of total doses being at least half of the required dose in an inert atmosphere, the irradiation cost will drop by the same amount;

The optional use of antioxidants allows the use of very low dose rates in the presence of significant amounts of oxygen without extensive polymer oxidation;

By permitting with great ease and versatility the use of commercial gamma sources, the process of the present invention renders production possible without the huge investments associated to the irradiation technology.

The following Examples should not be construed as limiting the invention.

### EXAMPLES

### Examples 1 to 20

Four Series of Experiments were Prepared:

Series 1:

This is a series of comparative experiments, since only gaseous nitrogen was used, therefore without the addition of crosslinking promoting gases.

Thus, a 10 g weight of PP spheres of the kind usually available in the market having melt index 1.5, of Mn 46,425 and Mw 477,700 was placed in a low density irradiated polyethylene (XPE) bag having a gel content higher than 60% to resist temperatures higher than the crystalline melting of the PE. The plastic bag was successively purged with an inert gas such as gaseous N₂ having an oxygen content lower than 0.004%. The bag was left standing for a period of 15 hours to eliminate the dissolved residual oxygen and attain the O₂ equilibrium concentration. After this period, N₂ was removed again and a new charge of this inert gas was added. The samples were irradiated at varied radiation doses. After the irradiation the product was submitted in the recombination step to heating in an oven at 60° C. during 1 hour and in the termination step to heating at 130° C. during 1 hour. The obtained results are listed in TABLE 1 below.

In TABLE 1, Examples 1 to 4 show the remarkable effect of irradiation to the promotion of degradation until the dose of 15 kGy, in view of the continued reduction in the intrinsic viscosity of 3.07 dl/g to 1.83 dl/g. In Example 5, at the 20 kGy dose; it is found that the intrinsic viscosity starts to increase again and in Example 6, at the 40 kGy dose, said property becomes equivalent to the virgin polymer, that is, not irradiated. Sample 7 confirms that giant molecules are being formed, since the intrinsic viscosity can no longer be measured by virtue of the formation of a gel fraction.

TABLE 1

| | | Intrinsic | |
|---|---|---|---|
| | Dose | Viscosity | Gel |
| Example | (kGy) | (dl/g) | (%) |
| 1 | 0 | 3.07 | 0 |
| 2 | 2.5 | 2.57 | 0 |
| 3 | 5 | 2.35 | 0 |
| 4 | 15 | 1.83 | 0 |
| 5 | 20 | 1.90 | 0 |
| 6 | 40 | 3.09 | 0 |
| 7 | 80 | — | 5 |

For sample 5, the swelling test of the extrudate effected in an extrusion plastometer (ASTM D-1238) provided a swelling of 66% vs. 22% for the virgin sample.

The above results strongly confirm that it is possible to prepare A polypropylene of high melt strength with the aid of the known technique of irradiation on an inert sample followed by heating under an also inert atmosphere.

Series 2:

This is a series of Examples according to the present invention, where the polymer is irradiated in the presence of a crosslinking promoting gas such as acetylene.

Thus, samples of linear polypropylene of Mn 46,425 and Mw 477,700 were conditioned in an acetylene atmosphere at ambient pressure, in XPE bags that withstand temperatures until 200° C. and then irradiated in an acetylene atmosphere at various doses. Afterwards, all samples were heated in two steps as described earlier. The data obtained are listed in TABLE 2 below.

Results show an effect that is similar to that recorded for series 1; however, it may be seen that the inversion for the degradation trend occurs at lower doses, even for a lower molecular weight polymer. It is found that from the 5 kGy dose (example 10) the melt strength (MS) starts to increase and the extensibility increases more than 20%. For Example 11, a sharp increase in the melt strength is found with a continued increase in extensibility, this clearly showing the effect of acetylene as a crosslinking promoter by grafting long chains and forming crosslinks below the gel point.

TABLE 2

| | | Intrisic | | | | |
|---|---|---|---|---|---|---|
| | Dose | Visc | | | MS | Extensibility |
| Example | (kGy) | (dl/g) | Mn | Mw | (cN) | (cm/s) |
| 8 | 0 | 2.44 | 46425 | 477700 | 22.5 | 10.1 |
| 9 | 1 | 2.09 | 49150 | 435350 | 18.3 | 11.8 |
| 10 | 5 | 1.81 | 64933 | 276100 | 20.5 | 12.8 |
| 11 | 10 | 2.05 | 50543 | 355890 | 28.4 | 13.4 |

Series 3:

This is a series of Examples according to the present invention that aim at demonstrating without any doubt the efficiency of acetylene in promoting the crosslinking of PP and the efficiency of thermal treatment in increasing the crosslinking level whatever the heating atmosphere.

Thus in Examples 12, 13 and 14, samples of linear polypropylene having Mn 46,425 and Mw 477,700 were conditioned in an acetylene atmosphere, N₂ atmosphere of purity higher than 99.99% and under air atmosphere, all at ambient pressure, in XPE bags that withstand temperatures of up to 200° C., the samples being irradiated with 45 kGy at the same atmosphere of the conditioning at various doses. Then all the samples were heated in two steps as described previously. In Examples 15 and 16, the samples were irradiated with 45 kGy under acetylene atmosphere; however they were heated in an inert atmosphere (N₂) and degrading atmosphere (air) as a consequence of the presence of oxygen. The obtained data are collected in TABLE 3 below.

The comparison of the results of Examples 12, 13 and 14 shows that the PP alone irradiated with a total dose of 45 kGy and heated according to the process suggested in the present invention yields a significant amount of gel, that is 28.8%, which is typical of a highly crosslinked sample, while the PP irradiated under inert (N₂) or degrading atmosphere does not yield gel. Examples 15 and 16 show that the positive effects for acetylene recombination are produced in the irradiation as well as in the heating steps. Example 16 shows that the presence of oxygen even at natural concentrations such as those found in ambient air, does not preclude that acetylene causes a great crosslink increase.

TABLE 3

| | Irradiation | Heating | Dose | Gel Fraction |
|---|---|---|---|---|
| Example | atmosphere | atmosphere | (kGy) | (%) |
| 12 | Acetylene | Acetylene | 45 | 28.8 |
| 13 | N₂ | N₂ | 45 | 0 |
| 14 | Air | Air | 45 | 0 |
| 15 | Acetylene | N₂ | 45 | 18.8 |
| 16 | Acetylene | Air | 45 | 4.9 |

Series 4:

This is a series of Examples according to the invention, where the polymer is irradiated in the presence of acetylene as a crosslinking promoting gas. Results from experiments effected at different recombination and termination steps are compared.

Thus, 2.5 kg polypropylene homopolymer as pellets having melt index 1.5, with Mn 46,425 and Mw 477,700 was placed in a stainless steel vessel provided with a sealed cap. The vessel was purged with acetylene and left standing for 12 hours. Then another gas purge with acetylene was carried out and the internal pressure kept at 1 absolute atmosphere. Three vessels were prepared, each containing 2.5 kg of the same polypropylene. The vessels were irradiated with a radiation dose of 12 kGy. After the irradiation the irradiated samples were submitted to different recombination and termination steps and were tested. The test results are shown in TABLE 4 below. Example 17, the original, non irradiated polypropylene, is shown as control.

Example 18 shows the results for the test of one sample that after irradiation was submitted to heating during 2 hours in an oven at 80° C., and then submitted to the termination step for 15 minutes at 120° C. in an oven. The two treating steps were effected with the polypropylene in the interior of the stainless steel vessel.

Examples 19 and 20 show the test results of two samples that after irradiation were submitted to the recombination step, when they remained at ambient temperature for 24 hours and 20 days respectively, waiting for the termination step. The termination step of these two samples was carried out in an extruder, with the temperature of polypropylene at the exit of the extruder being 188° C. The residence time in the interior of the extruder was respectively 1.5 and 1.2 minutes.

Examples 18, 19 and 20 presented below, show the increase in melt strength and extensibility based on the base resin presented as control in example 17. This way the various recombination and termination steps applied to polypropylene and its copolymers irradiated in the presence of crosslinking promoting gases are shown, evidencing the effects caused by the variation in the experimental conditions of said steps.

TABLE 4

| Ex- | | | | | |
|---|---|---|---|---|---|
| am- | Recombi- | Termination | MS | Extensibility | Final MI |
| ple | nation Step | Step | (cN) | (cm/s) | (g/10 min) |
| 17 | — | — | 16.3 | 7.9 | 1.5 |
| 18 | 2 h/80° C./ | 15 min/120° C. | 50.7 | 10.7 | 2.0 |
| | acetylene | in oven/ | | | |
| | | acetylene | | | |
| 19 | 24 h/25° C./ | 1.5 min/ | 67.8 | 9.12 | 2.0 |
| | acetylene | 188° C. in | | | |
| | | extruder | | | |
| 20 | 20 days/25° C./ | 1.2 min/ | 77.9 | 9.0 | 0.67 |
| | acetylene | 188° C. in | | | |
| | | extruder | | | |

### Examples 21 to 30

Series 5:

This is a series of Examples according to the present invention, where the polymer is irradiated in the presence of a phenolic antioxidant, used as a stabilizer for radicals and acetylene, used as radical scavenging gas and crosslinking promoter.

2000 g PP as spheres or extrudates of the kind normally available in the market the molecular weight of which is specified in TABLE 5 below. The spheres did not contain any antioxidant and the extrudates were prepared through the usual process for extrusion of PP from the usual phenolic antioxidant-containing spheres, so that after pelletization the antioxidants are solubilized and dispersed in its amorphous area. The samples were placed in a plastic vessel that could withstand upper temperatures close to 200° C. The plastic vessel was filled with gaseous acetylene that was immediately withdrawn. This process was repeated three times and the vessel was left for a period of 15 hours to withdraw the dissolved air. After that period, the acetylene was again withdrawn and a fresh charge of the gas that is a radical scavenger and that accelerates the crosslinking and grafting reactions was added. The samples were irradiated at varied radiation doses from a gamma (*) or electron (e−) source. In the irradiation carried out with electron accelerators as well as in the irradiation carried out with gamma sources, all care was taken so that the dose was homogeneously distributed throughout the sample.

In all the examples to follow, the polymer used was a commercial polypropylene homopolymer having Melt Index 3.5 g/10 min, the PP as spheres corresponding to the virgin polymer without antioxidant while extruded PP contained 0.001 weight % antioxidant dispersed in the amorphous phase. To the above-cited polymers were added acetylene at atmospheric pressure and the acetylene atmosphere was kept during the irradiation and the thermal treatment steps.

Example 21 relates to an extruded PP that was not irradiated. In examples 22, 23 and 24 spheres of the same antioxidant-free PP have been irradiated with electrons at doses of 3 to 15 kGy. According to the variation in Mz it is found that after a pronounced initial degradation in the molecules of higher molar weight, there is a trend towards stabilization and even a slight increase. The crystallization temperature shows significant increase normally associated to an increase in the melt strength, this indicating the presence of typical heterogeneities in a polymer having crosslink and grafts and possible formation of microgels in the polymer bulk.

In Example 25, the same kind of spheroidal PP was irradiated with gamma rays at a total dose of 10 kGy. A slight increase in the melt strength was found, together with a small increase in extensibility. The comparison of example 25 and example 26 clearly demonstrates the effect caused by the presence of a stabilizing substance dispersed by means of the extrusion in the amorphous phase of the polymer. It is observed that the two samples are identical, except for the presence of antioxidants in the sample in extruded form. This difference alone was enough to increase the melt strength in nearly three times. The same phenomenon is present in examples 27 and 28.

TABLE 5

| | | Stabilizing | MS | Ext. | Tc | | | |
|---|---|---|---|---|---|---|---|---|
| Ex. | SAMPLE | Substance | (cN) | Cm/s | (° C.) | Mn | Mw | Mz |
| 21 | PP extruded | No | 10.3 | 9.3 | 114 | 72900 | 380800 | 1274000 |
| 22 | Spheres | No | — | — | 114 | 51000 | 245700 | 765400 |
| | 3 kGy. e- | | | | | | | |
| 23 | Spheres | No | — | — | 120 | 47000 | 245200 | 892600 |
| | 10 kGy. e- | | | | | | | |
| 24 | Spheres | No | — | — | 120 | 41100 | 221300 | 937600 |
| | 15 kGy. e- | | | | | | | |
| 25 | Spheres | No | 13.2 | 10.6 | 114 | 50600 | 254800 | 803000 |
| | 10 kGy. γ | | | | | | | |
| 26 | Extruded | Phenolic Antiox. | 32.6 | 9.8 | 116 | 66800 | 382800 | 1338000 |
| | 10 kGy, γ | 0.001% w | | | | | | |
| 27 | Extruded. | Phenol Antiox. | 31.1 | 10.9 | 120 | 59600 | 350100 | 1132000 |
| | 15 kGy. γ | 0.001% w | | | | | | |
| 28 | Extruded. | Phenol.Antiox. | 33.3 | 12.4 | 121 | 51400 | 316800 | 1012000 |
| | 20 kGy. γ | 0.001% w | | | | | | |
| 29 | Extruded. | PhenolAntiox. | 10.9 | 12.1 | 121 | 54300 | 260000 | 741800 |
| | 15 kGy. e- | 0.001% w | | | | | | |
| 30 | Extruded. | Phenol Antiox. | 15.4 | 10.8 | 121 | 55000 | 255900 | 726100 |
| | 20 kGy. e- | 0.001% w | | | | | | |

Examples 29 and 30, when compared to examples 27 and 28 respectively, show that when the polymers are electron-irradiated, the melt strength data are well behind those obtained with gamma irradiation. The data obtained from gel permeation chromatography shows that upon gamma irradiation, the growing of giant molecules of molecular weight (Mz) higher than 106 is favored. In view of the fact that the difference between a gamma source irradiation and an electron accelerator is mainly the dose rate, that is the rate at which the sample is irradiated, it may be concluded that the gamma source offers more possibilities of molecular recombination.

Example 24 when compared to example 29 shows that the antioxidants were of little use in protecting the molecules of higher molecular weight and the conspicuous increase in the melt strength shows that grafts or crosslinks were formed with low molar weight portions.

Therefore, the application of the process disclosed in the present invention leads to the manufacture of polypropylene and its copolymers of high melt strength free of residual contamination, keeping melt index suitable for processing.

Polypropylene and its copolymers obtained through the process disclosed in the present invention present the ratio between the melt strength of polypropylene and its copolymers grafted and crosslinked and the melt strength of a virgin polypropylene and its copolymers of same melt index, higher than 1, and more specifically between 1.01 and 20. The melt index of the products obtained through the process disclosed in the present invention is suitable for processing, more specifically it is between 0.1 g/10 min and 20 g/10 min.

The polypropylene and its copolymers of high melt strength obtained by applying the process disclosed in the present invention is suitable for manufacturing high density foam, coating films, thermoformed parts free of residual stress, blow molding of large parts, plate extrusion and other applications where high melt strength is required.

### Examples 31 to 34

Analogously to examples 0.21 to 30, a PP copolymer and its compound samples were irradiated to confirm the validity of the process also in the polypropylene modified with other comonomers. The extrudates were prepared through the usual process for extrusion of PP from the usual phenolic antioxidant-containing spheres, so that after pelletization the antioxidants are solubilized and dispersed in its amorphous area. The samples were placed in a metallic vessel that could withstand upper temperatures close to 200° C. The metallic vessel was filled with gaseous acetylene that was immediately withdrawn. This process was repeated three times and the vessel was left for a period of 15 hours to withdraw the dissolved air. After that period, the acetylene was again withdrawn and a fresh charge of the gas that is a radical scavenger and that accelerates the crosslinking and grafting reactions was added. The samples were irradiated in gamma (*) source and 12,5 kGy dose. In the, all care was taken so that the dose was homogeneously distributed throughout the sample. After irradiation, the metallic vessel was kept closed for one week at room temperature, intending to enhance the recombination of the free radicals.

The final treatment involved a step of heating the material for 1 hour at 60° C. and more one hour at 130° C. in order to promote final recombination and elimination of the free radicals, respectively. The results are reported on TABLE 6. The sample 31 is a copolymer containing a PP homopolymer matrix and a dispersed phase of a propylene and ethylene random copolymer. The total content of ethylene in the sample is about 15 weight %. The, sample 33 is a compound containing the sample 31, plus 10 weight % of PP homopolymer with melt index 20 g/10 min, plus 20 weight % talc and plus 1,5 weight % of carbon black. The samples 32 and 34 the corresponding irradiated samples. It was observed that the increase in melt strength is evident when the samples are irradiated according the present application, even for PP copolymers and its compounds.

TABLE 6

| | Stabilizing | | | dose | Melt Index | MS | Ext. |
|---|---|---|---|---|---|---|---|
| Ex. | Substance | Composition | Irradiation | [kGy] | [g/10 min] | [cN] | [cm/s] |
| 31 | Phenolic Antiox. | Copolymer | No | — | 4.9 | 12.6 | 7.5 |
| | 0.001% w | | | | | | |
| 32 | Phenolic Antiox. | Copolymer | g | 12.5 | 2.9 | 48.4 | 11.0 |
| | 0.001% w | | | | | | |
| 33 | Phenolic Antiox. | Compound of | No | — | 5.1 | 5.3 | 6.6 |
| | 0.001% w | the copolymer | | | | | |
| 34 | Phenolic Antiox. | Compound of | g | 12.5 | 1.6 | 52.1 | 8.8 |
| | 0.001% w | the copolymer | | | | | |

1. A process for preparing polypropylene and its copolymers having high melt strength, wherein said process comprises the steps of:
Irradiating with the aid of low dose ionizing radiation, a polymer of polypropylene and its copolymers in the presence of a reactive atmosphere, containing at least one crosslinking promoting gas, so as to obtain a polypropylene that is crosslinked and grafted with high molecular weight chain portions;
In a first treating step, herein called recombination step, keeping the so-irradiated polypropylene and its copolymers at a temperature, for a period of time, that makes possible to recombine most of the free radicals still remaining;
In a second treating step, herein called termination step, annihilating any remaining free radicals from the crosslinked and grafted polypropylene and its copolymers.

2. A process according to claim 1, wherein the crosslinking promoting gas is an acetylene compound (HC≡CR₁), an allene compound (CH₂═C═CR₁R₂) or a vinyl compound (R₂R₁C═CR₃R₄), alone or combined with each other.

3. A process according to claims 1 and 2, wherein the so-called crosslinked promoting gas, selected among the so-called acetylene compounds, is acetylene, methyl acetylene, ethyl acetylene, propyl acetylene and vinyl acetylene.

4. A process according to claims 1 and 2, wherein the so-called crosslinking promoting gas, selected among the so-called allene compounds, is propadiene and 1,2-butadiene.

5. A process according to claims 1 and 2, wherein the so-called crosslinking promoting gas, selected among the so-called vinyl compounds, is 1,3-butadiene, ethene, propene, 1-butene, iso-butene, vinyl chloride, vinylidene chloride, vinylidene fluoride, chlorotrifluoro ethylene, and tetrafluoro ethylene.

6. A process according to claim 1, wherein the reactive atmosphere is preferably free of oxygen.

7. A process according to claim 1, wherein the reactive atmosphere may contain oxygen until the concentration of 28 mole %.

8. A process according to claims 1, 6 and 7, wherein the reactive atmosphere may be formed by an inert gas alone or in admixture.

9. A process according to claim 8, wherein the inert gas is a gas selected among methane, ethane, propane, nitrogen, helium and argon.

10. A process according to claims 1, 6 and 7, wherein the reactive atmosphere may contain a radical scavenging gas.

11. A process according to claims 1 and 10, wherein the so-called termination step, where any remaining free radicals are annihilated by means of termination reactions, is carried out thermally or through radical scavenging gases.

12. A process according to claim 1, wherein the overall pressure of the reaction system during irradiation is situated between 0.5 bar and 20 bar absolute pressure.

13. A process according to claims 1 and 12, wherein the crosslinking promoting gas is used at partial pressure between 0.01% and 100% of the reaction system pressure during irradiation.

14. A process according to claims 1, 12 and 13, wherein the crosslinking promoting gas is used at partial pressure between 10% and 100% of the reaction system pressure during irradiation.

15. A process according to claims 1, 10, 11 and 12, wherein the radical scavenging gas is used at partial pressure, between 0% and 99.9% of the reaction system pressure during irradiation.

16. A process according to claims 1, 10, 11, 12 and 15; wherein the radical scavenging gas is used at partial pressure between 0.01% and 90% of the reaction system pressure during irradiation.

17. A process during claim 1, wherein the so-called recombination step is carried out at a temperature situation between 10° C. and 100° C., during a period of time between 5-minutes and 1 month.

18. A process according to claims 1 and 11, wherein the so-called termination step carried out thermally is carried out in an oven or in an extruder.

19. A process according to claims 1, 11, and 18, wherein the so-called termination step is carried out thermally in an oven, where the irradiated polypropylene and its copolymers is submitted to the temperature between 100° C. and 155° C., for a period of time between 0.1 and 100 minutes.

20. A process according to claims 1, 11 and 18, wherein the so-called termination step is carried out thermally in an extruder, where the irradiated polypropylene and its copolymers is submitted to a temperature between 175° C. and 260° C. for a period of time during 1 to 5 minutes.

21. A process according to claims 1, 10, 11, 15 and 16, wherein the so-called termination step is carried out in the presence of the radical scavenging gas, where the irradiated polypropylene and its copolymers is submitted to a temperature between 10° C. and 180° C. for a period of time between 0.1 and 100 minutes.

22. A process according to claims 1, 10, 11, 15, 16 and 21, wherein the radical scavenging gas is selected between methylmercaptan and nitric oxide.

23. A process according to claim 1, wherein the ionizing radiation is from gamma ray sources, X ray sources electron accelerators and electron accelerators with X ray converters.

24. A process according to claims 1 and 23, wherein, the irradiation dose is comprised between 5 and 80 kGy.

25. A process according to claims 1 and 23, wherein the irradiation dose is comprised between 10 and 40 kGy.

26. A process according to claims 1 and 23, wherein the typical irradiation dose is comprised between 1 kGy/h and 60,000 kGy/h.

27. A process according to claim 1, wherein the irradiation, recombination and termination steps may be continuous.

28. A process according to claim 1, wherein the irradiation, recombination and termination steps may be under batch process.

29. A process according to claim 1, wherein the irradiation, recombination and termination steps may be carried out in the same vessel.

30. A process according to claim 1, wherein the value of Mn for polypropylene and its copolymers is between 40,000 and 100,000 and the value of Mw is between 100,000 and 4,000,000.

31. A process according to claim 1, wherein the isotacticity of polypropylene and its copolymers is higher than 80% and lower than 99.9%.

32. A process according to claim 1, wherein the polypropylene, and its copolymers are impregnated with the gases of the reactive atmosphere for at least 1 minute until 24 hours.

33. A process according to claim 1, wherein the copolymers of polypropylene have as monomers, besides propene, compounds such as CH₂═CHR, where R is a linear or branched alkyl radical, having between two and eight carbon atoms, and may be solely one hydrogen atom.

34. A process according to claims 1 and 33, wherein the polypropylene; comonomers have as monomers besides propene, ethene, 1-butene, 1-pentene, 1-hexene, 1-heptene, 1-octene, 1-nonene, and 1-decene.

35. A process according to claim 1, wherein polypropylene and its copolymers are have the shape of pellets, extrudates, spheres or powder.

36. A process according to claims 1, 2, 3, 4 and 5, wherein prior to the irradiation step, stabilizing substances are added to the polypropylene and its copolymers, so that such substances are dispersed in the amorphous phase of the polypropylene.

37. A process according to claims 1 and 36, wherein the addition of the stabilizing substances to the amorphous phase of the polypropylene and its copolymers is carried out with the aid of any of the well-known techniques for dispersing substances in the amorphous phase, preferably such addition is carried out by means of extrusion or pelletizing of the stabilizing substances with the polymer.

38. A process according to claims 1 and 36, wherein the irradiation with ionizing radiation at low doses of the polypropylene and its copolymers is carried out in the presence of admixed stabilizing substances and of crosslinking promoters.

39. A process according to claims 1, 10, and 36, wherein the irradiation with low doses of ionizing radiation of polypropylene and its copolymers is carried out in the presence of stabilizing substances, crosslinking promoters and gaseous radical scavengers.

40. A process according to claims 1 and 36, wherein the stabilizing substances are substances used against thermo-oxidative degrading reactions.

41. A process according to claims 1, 36 and 40, wherein the stabilizing substances are monofunctional pure substances containing a chemical group that works by:
a) Hydrogen donation
b) Radical scavenging
c) Hydroperoxide decomposition.

42. A process according to claims 1, 36 and 40, wherein the stabilizing substances are pure bifunctional substances or polyfunctional substances containing two or more chemical groups that work by:
a) Hydrogen donation
b) Radical scavenging
c) Hydroperoxide decomposition.

43. A process according to claims 1, 36, 40, 41 and 42, wherein the stabilizing substances are made up of a mixture of at least 2 monofunctional, bifunctional or polyfunctional substances that contain chemical groupsthat work by:
a) Hydrogen donation
b) Radical scavenging
c) Hydroperoxide decomposition.

44. A process according to claims 41, 42 and 43, wherein the chemical groups that work by hydrogen donation are phenolic antioxidants, aromatic amines, sterically hindered amines and hydroxylamines.

45. A process according to claims 41, 42 and 43, wherein the chemical groups that work by radical scavenging are unsaturated groups.

46. A process according to claim 45, wherein the compounds containing unsaturated groups are monomers or oligomers.

47. A process according to claim 45, wherein the compounds containing unsaturated groups are the very gases used as crosslinking promoters.

48. A process according to claims 45, 46 and 47, wherein the compound containing unsaturated groups is an acetylene compound (HC≡CR1), allene compound (CH₂═C═CR₁R₂) or a vinyl compound (R₂R₁C═CR₃R₄).

49. A process according to claim 48, wherein the acetylene compound is acetylene, methyl acetylene, ethyl acetylene, propyl acetylene and vinyl acetylene.

50. A process according to claim 48, wherein the allene compound is propadiene and 1,2-butadiene.

51. A process according to claim 48, wherein the vinyl compound is 1,3-butadiene, ethene, propene, 1-butene, iso-butene, vinyl chloride, vinilydene chloride, vinylidene fluoride, chlorotrifluoroethylene and tetrafluoroethylene.

52. A process according to claims 41, 42 and 43, wherein the chemical groups that work by radical scavenging are related to benzofuranones.

53. A process according to claims 41, 42 and 43, wherein the chemical groups that work by hydroperoxide decomposition are phosphites, phosphonites and organosulfur compounds.

54. A process according to claim 36, wherein the stabilizing substances against thermo oxidative reactions are used alone or as a complement to the second treatment step aiming at annihilating any remaining free radicals.

55. Products obtained according to the processes of claims 1, 34, 35 and 36, wherein the polypropylene and its copolymers, grafted and crosslinked, is of high melt strength, free of residual contamination while keeping melt index level suitable for processing.

56. A product obtained according to the processes of claims 1, 34, 35 and 36, wherein the ratio between the melt strength of the polypropylene and its copolymers, grafted and crosslinked, and the melt strength of a virgin polypropylene and its copolymers of same melt index, is higher than 1, more specifically between 1.01 and 20.

57. A product according to the process of claims 1, 34, 35 and 36, wherein the polypropylene and its copolymers, grafted and crosslinked, are of melt index between 0.1 g/10 min and 20 g/10 min.

58. A product obtained according to the process of claims 1, 34, 35 and 36, wherein the polypropylene and its copolymers, grafted, and crosslinked, is useful for the manufacture of low density foams, coating films, thermoformed parts free of residual stresses, blow molding of large parts, plate extrusion and other applications where a high melt strength is required.
